(19) United States
(12) Patent Application Publication
(10) Pub. No.: US 2022/0048061 A1
(43) Pub. Date: Feb. 17, 2022

(54) SUBSTRATE TREATING APPARATUS AND METHODS

(71) Applicant: CORNING INCORPORATED, CORNING, NY (US)

(72) Inventors: Gabriel Pierce Agnello, Corning, NY (US); Hironori Fukuyama, Iwata city, Shizuoka (JP); Tomoyuki Nakamura, Hamamatsu-city, Shizuoka-prefecture (JP); Jia Zhang, Painted Post, NY (US)

(21) Appl. No.: 17/278,895

(22) PCT Filed: Sep. 17, 2019
(86) PCT No.: PCT/US2019/051494

§ 371 Date: Mar. 23, 2021

Related U.S. Application Data
(60) Provisional application No. 62/737,150, filed on Sep. 27, 2018.

(51) Int. Cl. B05C 1/08

(52) U.S. Cl. CPC B05C 1/0808; B05C 1/0813

(57) ABSTRACT

A substrate treating apparatus comprises a container comprising a reservoir and a roller rotatably mounted relative to the container. A portion of an outer periphery of the roller is positioned in the reservoir. The outer periphery comprises a first groove comprising a width greater than at least twice a depth of the first groove. Additionally, methods of treating a substrate with the substrate treating apparatus are disclosed.

### CROSS-REFERENCE TO RELATED APPLICATIONS

This application claims the benefit of priority of U.S. Provisional Application Ser. No. 62/737,150 filed on Sep. 27, 2018 the contents of which are relied upon and incorporated herein by reference in their entirety as if full set forth below.

### FIELD

The present disclosure relates generally to methods for treating a substrate and, more particularly, to methods for treating a substrate with a substrate treating apparatus comprising a roller.

### BACKGROUND

It is known to treat a first major surface of a substrate with a treatment liquid designed to etch the first major surface of the substrate. This treatment liquid may splash onto an opposing second major surface of the substrate. Additionally, inconsistencies in treatment may arise due to differing amounts of the etchant being applied to the first major surface of the substrate.

### SUMMARY

The following presents a simplified summary of the disclosure to provide a basic understanding of some embodiments described in the detailed description.

In accordance with some embodiments, a substrate treating apparatus can comprise a container comprising a reservoir. The substrate treating apparatus can comprise a rotatably mounted relative to the container. A portion of an outer periphery of the roller may be positioned in the reservoir. The outer periphery can comprise a first groove comprising a width greater than at least twice a depth of the first groove.

In some embodiments, the first groove can comprise a bottom wall and a pair of sidewalls.

In some embodiments, one or more sidewalls of the pair of sidewalls can define an angle relative to the bottom wall that may be from about 60 degrees to about 170 degrees.

In some embodiments, the angle is from about 60 degrees to about 95 degrees.

In some embodiments, the first groove can extend along a first groove axis that may be substantially parallel to a roller axis along which the roller extends and about which the roller rotates.

In some embodiments, the first groove may be helically wound about the roller.

In some embodiments, the depth of the groove may be non-constant along one or more of the width of the groove or a length of the groove.

In some embodiments, a substrate treating apparatus can comprise a container comprising a reservoir and a roller rotatably mounted relative to the container about a roller axis along which the roller extends. A portion of an outer periphery of the roller can be positioned in the reservoir. The outer periphery can comprise a first groove extending between a first end and a second end of the roller.

In some embodiments, the roller can comprise a porous material.

In some embodiments, the reservoir can contain a treatment liquid.

In some embodiments, the portion of the outer periphery of the roller positioned in the reservoir can be in contact with the treatment liquid.

In some embodiments, the first groove can comprise a bottom wall and a pair of sidewalls.

In some embodiments, one or more sidewalls of the pair of sidewalls can define an angle relative to the bottom wall that may be from about 60 degrees to about 170 degrees.

In some embodiments, the angle is from about 60 degrees to about 95 degrees.

In some embodiments, the first groove can extend along a first groove axis that may be substantially parallel to the roller axis.

In some embodiments, the first groove can be helically wound about the roller.

In some embodiments, methods of treating a substrate can comprise contacting a treatment liquid contained in a reservoir of a container with a portion of an outer periphery of a roller, with the outer periphery comprising a first groove. Methods can further comprise rotating the roller about a roller axis to distribute the treatment liquid around the outer periphery and within the first groove. Methods can further comprise transferring the treatment liquid from the outer periphery to a first major surface of the substrate as the roller rotates.

In some embodiments, the contacting the treatment liquid contained in the reservoir of the container with the portion of the outer periphery of the roller can cause the treatment liquid to enter the first groove.

In some embodiments, the contacting the treatment liquid contained in the reservoir of the container with the portion of the outer periphery of the roller can comprise immersing the portion of the outer periphery of the roller in the treatment liquid contained in the reservoir.

In some embodiments, methods can comprise moving the substrate along a travel direction of a travel path as the roller rotates about the roller axis.

In some embodiments, the treatment liquid can comprise one or more of an etchant, an ink, a liquid polymer, or water.

### BRIEF DESCRIPTION OF THE DRAWINGS

These and other features, embodiments and advantages are better understood when the following detailed description is read with reference to the accompanying drawings, in which:

FIG. 1 schematically illustrates a substrate treating apparatus in accordance with embodiments of the disclosure;

FIG. 2 illustrates an enlarged view of some embodiments of the substrate treating apparatus at view 2 of FIG. 1 with a roller in contact with a treatment liquid;

FIG. 3 illustrates a perspective view of some embodiments of the roller with a plurality of grooves extending substantially parallel to a roller axis along which the roller extends;

FIG. 4 illustrates a perspective view of some embodiments of the roller with a plurality of grooves helically wound about the roller;

FIG. 5 illustrates an enlarged view of some embodiments of the substrate treating apparatus at view 5 of FIG. 4 with some of the grooves helically wound about the roller;

FIG. 6 illustrates an enlarged view of some embodiments of a first groove of the roller at view 6 of FIG. 5 with the first groove comprising a non-chamfered shape;

FIG. 7 illustrates an enlarged view of additional embodiments of the first groove;

FIG. 8 illustrates an enlarged view of yet additional embodiments of the first groove;

FIG. 9 illustrates an enlarged view of yet additional embodiments of the first groove;

FIG. 10 illustrates an enlarged view of yet additional embodiments of the first groove;

FIG. 11 illustrates a plot of some embodiments of a width of the first groove and a depth of the first groove;

FIG. 12 illustrates a plot of some embodiments of the depth of the first groove and a state of the treatment liquid for varying widths of the first groove; and

FIG. 13 illustrates a plot of some embodiments of the depth of the first groove and a state of the treatment liquid for chamfered and non-chamfered grooves.

### DETAILED DESCRIPTION

Embodiments will now be described more fully hereinafter with reference to the accompanying drawings in which embodiments are shown. Whenever possible, the same reference numerals are used throughout the drawings to refer to the same or like parts. However, this disclosure may be embodied in many different forms and should not be construed as limited to the embodiments set forth herein.

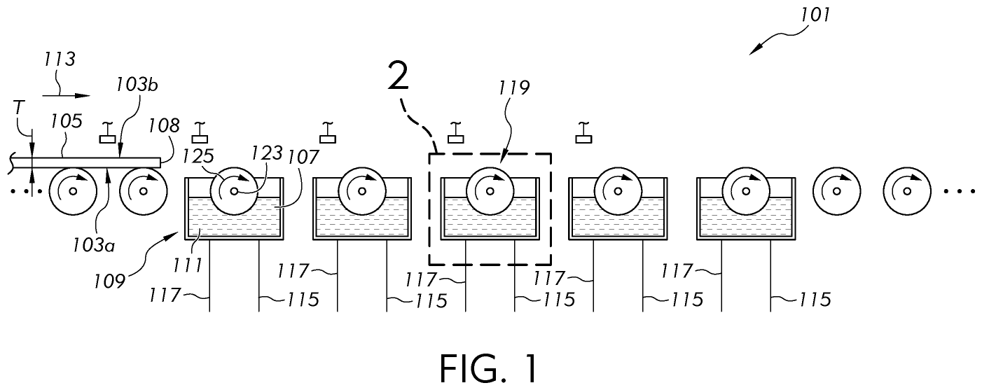

It may be understood that specific embodiments disclosed herein are intended to be exemplary and therefore non-limiting. Methods and apparatus for treating a substrate will now be described by way of embodiments for treating a substrate with a substrate treating apparatus 101. FIG. 1 is a schematic view of the substrate treating apparatus 101 in accordance with embodiments of the disclosure. The substrate treating apparatus 101 can treat a first major surface 103a of a substrate 105 with a treatment liquid 107. As shown, the substrate 105 can further comprise a second major surface 103b that opposes the first major surface 103a. A thickness “T” of the substrate 105 is between the first major surface 103a and the second major surface 103b. A wide range of thicknesses may be provided depending on the particular application. For example, the thickness “T” can comprise substrates comprising a thickness of from about 50 micrometers (microns, μm) to about 1 centimeter (cm), for example, from about 50 μm to about 1 millimeter (mm), for example, from about 50 μm to 500 μm, for example, from about 50 μm to 300 μm.

In some embodiments, the thickness “T” of the substrate 105 can be substantially constant along one or more of a length of the substrate 105 (see FIG. 1) or a width of the substrate 105, with the width being perpendicular to the length. Although not shown, in further embodiments, the thickness “T” of the substrate 105 may vary along a length and/or width of the substrate 105. For instance, thickened edge portions (edge beads) may exist at outer opposed edges of the width that can result from the formation process of some substrates (e.g., a glass ribbon). Such edge beads may comprise a thickness that may be greater than a thickness of a high quality central portion of the glass ribbon. However, in some embodiments, such edge beads, if formed with the substrate 105, may already be separated from the substrate 105.

In some embodiments, the substrate 105 can comprise a glass ribbon or a glass ribbon that may comprise a glass sheet. For example, when the substrate 105 comprises the glass sheet, the substrate 105 may comprise a leading end 108 and a trailing end, wherein the length of the substrate 105 can extend between the leading end 108 and the trailing end. In further embodiments, the substrate 105 can comprise a ribbon that can be provided from a source of ribbon. In some embodiments, the source of ribbon can comprise a spool of ribbon that may be uncoiled to be treated by the substrate treating apparatus 101. For instance, the ribbon can be continuously uncoiled from a spool of ribbon while downstream portions of the ribbon may be treated with the substrate treating apparatus 101. Further, subsequent downstream processes (not shown), may separate the ribbon into sheets or may eventually coil the treated ribbon on a storage spool. In further embodiments, the source of ribbon can comprise a forming device that forms the substrate 105. In some embodiments, the ribbon can be continuously drawn from the forming device and treated with the substrate treating apparatus 101. Subsequently, in some embodiments, the treated ribbon may then be separated into one or more sheets. Alternatively, the treated ribbon may be subsequently coiled on a storage spool.

In some embodiments, the substrate 105 can comprise silicon (e.g., silicon wafer or silicon sheet), resin, or other materials. In further embodiments, the substrate 105 can comprise lithium fluoride (LiF), magnesium fluoride (MgF₂), calcium fluoride (CaF₂), barium fluoride (BaF₂), sapphire (Al₂O₃), zinc selenide (ZnSe), germanium (Ge) or other materials. In still further embodiments, the substrate 105 can comprise glass (e.g, aluminosilicate glass, borosilicate glass, soda-lime glass, etc.), glass-ceramic or other materials including glass. In some embodiments, the substrate 105 can comprise a glass ribbon or a glass ribbon comprising a glass sheet, and may be flexible with a thickness “T” of from about 50 μm to about 300 μm, although other range thicknesses and/or nonflexible configurations may be provided in further embodiments. In some embodiments, the substrate 105 (e.g., comprising glass or other optical material) may be used in various display applications such as liquid crystal displays (LCDs), electrophoretic displays (EPD), organic light emitting diode displays (OLEDs), plasma display panels (PDPs), or other applications.

The substrate treating apparatus 101 may be used to apply various types of treatment liquid 107 on the first major surface 103a of the substrate 105 depending on the intended attributes. For instance, in some embodiments, the treatment liquid 107 may comprise a paint, detergent, laminate, surface treatment, sealant, rinsing agent (e.g., water), chemical strengthening material, protectant material or other coating material. In further embodiments, the treatment liquid 107 may comprise one or more of an etchant, an ink, a liquid polymer, or water. The etchant can include a material etchant designed to etch the particular material forming the first major surface 103a of the substrate 105. In some embodiments, the etchant can comprise a glass etchant to etch the substrate 105 comprising glass at the first major surface 103a. In further embodiments, the etchant may comprise an etchant suitable to etch the substrate 105 comprising silicon at the first major surface 103a. In further embodiments, the etchant may be designed to etch away unmasked areas of the first major surface 103a of the substrate 105. In some embodiments, the etchant may be designed to etch away unmasked portions of an electrically conductive layer on a silicon wafer to form a semiconductor. In further embodiments, the etchant may be designed to provide a surface roughness of the first major surface 103a of the substrate 105 (e.g., a surface roughness to a glass substrate). For instance, an unmasked portion or the entire first major surface 103a of the substrate 105 may be etched to roughen the surface, thereby limiting unintended direct bonding (such as covalent bonding) between two substrates surfaces contacting one another. In further embodiments, etching may be used to modify optical properties of the substrate 105 or an unmasked portion of the substrate 105 being etched. Furthermore, etching may be used to reduce the thickness “T” of the substrate 105, clean the first major surface 103a of the substrate 105, or to provide other attributes.

The substrate treating apparatus 101 can comprise a container 109 comprising a reservoir 111 in which the treatment liquid 107 may be contained within the reservoir 111 of the container 109. As shown in FIG. 1, in some embodiments, the substrate treating apparatus 101 can comprise a plurality of containers 109 arranged in series along a travel direction 113 of the substrate 105. Although a single container 109 may be provided in non-illustrated embodiments, a plurality of containers 109 can increase the response time of changing an elevation of the treatment liquid 107 within the reservoir 111 and can also permit selective treatment rates for different portions of the substrate 105 traveling along the travel direction 113. In some embodiments, the treatment liquid 107 can be delivered from a source (e.g., a pump) to the container 109 via an inlet conduit 115. In some embodiments, excess treatment liquid 107 can be removed from the container 109 via an outlet conduit 117.

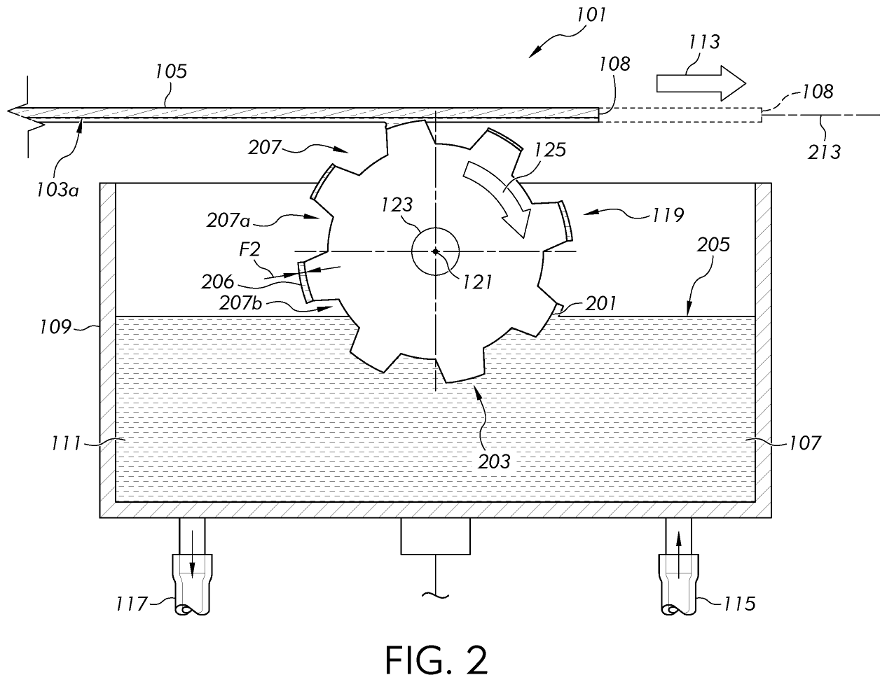

Referring to FIGS. 1-2, in some embodiments, the substrate treating apparatus 101 comprises a roller 119 rotatably mounted relative to the container 109. The roller 119 can be rotatably mounted relative to the container 109 about a roller axis 121 along which the roller 119 extends. The substrate treating apparatus 101 may comprise a drive mechanism that may be connected to the roller 119, for example, via a roller shaft 123 of the roller 119. The roller shaft 123 can extend along the roller axis 121. In some embodiments, the drive mechanism can apply a torque to the roller shaft 123 to impart rotational movement to the roller 119 about the roller axis 121 in a rotational direction 125. In some embodiments, the drive mechanism may comprise a motor that may be directly connected to the roller shaft 123.

Referring to FIG. 2, in some embodiments, the roller 119 may comprise a porous material. The porous material can comprise a closed-cell porous material, although open-cell porous material may readily absorb a quantity of liquid to enhance the liquid transfer rate from the reservoir 111 to the first major surface 103a of the substrate 105. The material defining an outer periphery 201 of the roller 119 is not limited to a porous material, and in further embodiments, the roller 119 can comprise a rigid or flexible material made from polyurethane, polypropylene or other material. Furthermore, in some embodiments, the outer periphery 201 of the roller 119 may comprise a roller nap of fabric and/or may include protrusions such as fibers, bristles, or filaments. In some embodiments, the roller 119 may comprise a monolithic cylinder of continuous composition and configuration throughout the entire roller. In further embodiments, the roller 119 may comprise one or more parts, such as an inner core and an outer layer disposed on the inner core, wherein the outer layer comprises the outer periphery 201 of the roller 119. In some embodiments, the inner core may comprise a solid inner core, although a hollow inner core may be provided. The inner core can facilitate transfer of torque to rotate the roller while the outer periphery 201 can be fabricated of a material that can provide the intended lifting of the treatment liquid 107 from the reservoir 111 and transfer of the treatment liquid 107 to the first major surface 103a of the substrate 105.

In some embodiments, the roller 119 may be partially positioned in the reservoir 111. By being partially positioned in the reservoir 111, a lower portion of the roller 119 may be below a plane defined by a top surface of the container 109 while an upper portion of the roller 119 may be above the plane defined by the top surface of the container 109. In some embodiments, a portion 203 of the outer periphery 201 of the roller 119 can be positioned in the reservoir 111, such as by being positioned in the reservoir 111 in contact with the treatment liquid 107. In some embodiments, the portion 203 of the outer periphery 201 that may be in contact with the treatment liquid 107 may comprise a depth below a surface of the treatment liquid 107 that may be less than half of a diameter of the roller 119. However, such a position is not intended to be limiting, and in further embodiments, a larger or a smaller portion of the outer periphery 201 can be positioned in the reservoir 111 in contact with the treatment liquid 107. With the outer periphery 201 contacting the treatment liquid 107, the treatment liquid 107 can accumulate on the outer periphery 201. For example, the treatment liquid 107 can form a layer 206 around the outer periphery 201. With the upper portion of the roller 119 positioned adjacent to the first major surface 103a of the substrate 105, the roller 119 can rotate in the rotational direction 125 about the roller axis 121, which can transfer the treatment liquid 107 from the outer periphery 201 to the first major surface 103a of the substrate 105.

The outer periphery 201 of the roller 119 can comprise a plurality of grooves 207. For example, the outer periphery 201 can comprise a first groove 207a, a second groove 207b, etc. In some embodiments, the plurality of grooves 207 can comprise channels, furrows, indentations, etc. within the outer periphery 201. Neighboring grooves 207 can be spaced apart from each other about the outer periphery 201. For example, the first groove 207a can be spaced a distance apart from the second groove 207b, which neighbors the first groove 207a. In some embodiments, a distance separating neighboring grooves can be constant, for example, with the distance separating the first groove 207a and the second groove 207b being the same as the distance separating the second groove 207b and a neighboring third groove, etc. In other embodiments, however, the distance separating neighboring grooves may be non-constant, as some neighboring grooves may be closer together than other neighboring grooves. For example, the distance separating the first groove 207a and the second groove 207b may be greater than or less than the distance separating the second groove 207b and a neighboring third groove, etc. In some embodiments, when the portion 203 of the outer periphery 201 of the roller 119 contacts the treatment liquid 107, the treatment liquid 107 enters the first groove 207a, the second groove 207b, etc. that may be at least partially submerged within the treatment liquid 107. As the roller 119 rotates in the rotational direction 125 about the roller axis 121, the grooves 207 can transport the treatment liquid 107 from the reservoir 111 towards the substrate 105.

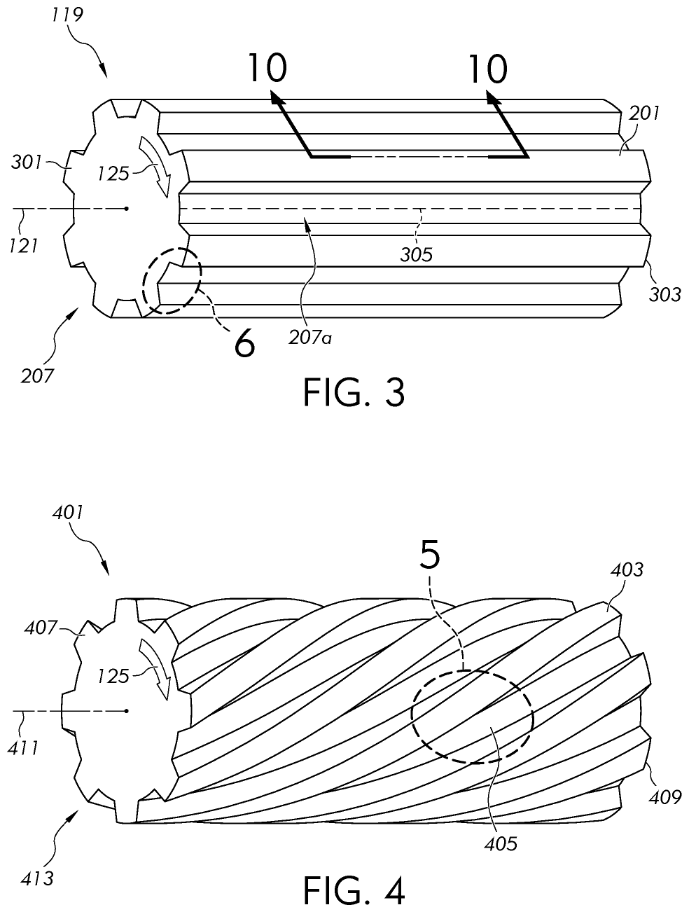

Referring to FIG. 3, some embodiments of the roller 119 of the substrate treating apparatus 101 are illustrated. In some embodiments, the outer periphery 201 comprises the first groove 207a extending between a first end 301 and a second end 303 of the roller 119. In some embodiments, by extending between the first end 301 and the second end 303, the first groove 207a extends along a first groove axis 305 that, as shown, may be substantially parallel to the roller axis 121 along which the roller 119 extends and about which the roller 119 rotates. In this way, the first groove 207a can extend longitudinally between the first end 301 and the second end 303 parallel to the roller axis 121. While the foregoing description of the structure and function of the roller 119 was made relative to the first groove 207a, it will be appreciated that the other grooves (e.g., the plurality of grooves 207) of the roller 119 may be substantially similar in structure and function to the first groove 207a. For example, one or more of the plurality of grooves 207 can extend between the first end 301 and the second end 303, with the plurality of grooves 207 extending between the first end 301 and the second end 303, along respective groove axes that may be substantially parallel to the roller axis 121 along which the roller 119 extends and about which the roller 119 rotates. As such, in some embodiments, the plurality of grooves 207 can extend substantially parallel to each other while extending substantially parallel to the roller axis 121.

Referring to FIG. 4, further embodiments of a roller 401 of the substrate treating apparatus 101 are illustrated. In some embodiments, an outer periphery 403 of the roller 401 can comprise a first groove 405 extending between a first end 407 and a second end 409 of the roller 401. In some embodiments, by extending between the first end 407 and the second end 409, the first groove 405 can be helically wound about the roller 401. For example, the first groove 405 can be helically wound about a roller axis 411 along which the roller 401 extends and about which the roller 401 rotates. In this way, the first groove 405 extends non-parallel to the roller axis 411 between the first end 407 and the second end 409. The first groove 405 can be partially or completely helically wound about the roller 401. For example, by being completely helically wound about the roller 401, the first groove 405 can extend at least 360 degrees about the roller 401. By being partially helically wound about the roller 401, the first groove 405 can extend less than 360 degrees about the roller 401, for example, by being helically wound over an angle from about 1 degree to about 359 degrees about the roller 401. While the foregoing description of the structure and function of the roller 401 was made relative to the first groove 405, it will be appreciated that the other grooves (e.g., a plurality of grooves 413) of the roller 401 may be substantially similar in structure and function to the first groove 405. For example, one or more of the plurality of grooves 413 can extend between the first end 407 and the second end 409, with the plurality of grooves 413 being helically wound about the roller 401. As such, in some embodiments, the plurality of grooves 413 can extend substantially parallel to each other while being helically wound about the roller 401.

It will be appreciated that the plurality of grooves 207, 413 of the rollers 119, 401 illustrated in FIGS. 3-4 are not limited to extending substantially parallel to each other. For example, the grooves 207 of the roller 119 illustrated in FIG. 3 are not limited to extending substantially parallel to the roller axis 121 along which the roller 119 extends. Likewise, the grooves 413 of the roller 401 illustrated in FIG. 4 are not limited to being helically wound about the roller 401. In some embodiments, the roller 119, 401 may comprise one or more of the grooves 207 extending substantially parallel to the roller axis 121 along which the roller 119 extends and one or more of the grooves 413 that may be helically wound about the roller 401. In this way, the roller 119, 401 may comprise grooves in which some of the grooves extend parallel to each other while some of the grooves may be non-parallel.

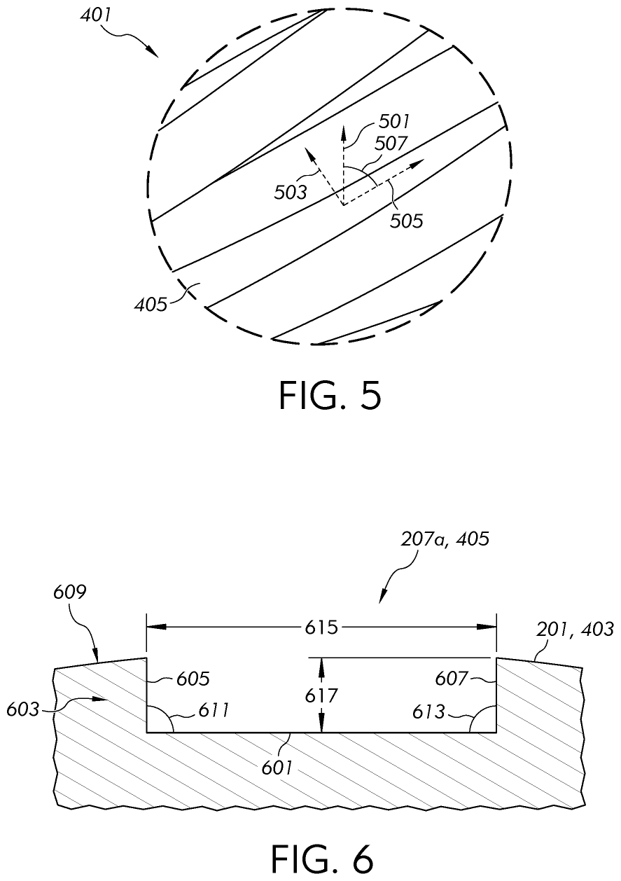

Referring to FIG. 5, some embodiments of the first groove 405 of the roller 401 are illustrated. As described herein, the first groove 405 can extend between the first end 301 and the second end 303 of the roller 401 while helically winding about the roller 401. A rotational velocity of the roller 401 rotating about the roller axis 121 in the rotational direction 125 may be represented by a vector 501 that may be oriented substantially vertically (e.g., along the rotational direction 125 of the roller 401). A first component 503 of the vector 501 may be oriented substantially perpendicular to an axis along which the first groove 405 extends, while a second component 505 of the vector 501 may be oriented substantially parallel to the axis along which the first groove 405 extends. An angle 507 may be defined between the vector 501 and the second component 505. In some embodiments, a relative velocity between the first groove 405 and the treatment liquid 107 accumulated within the first groove 405 may be represented by the equation (U)sin ϕ, with U representing the rotational velocity of the roller 401 (e.g., vector 501), and ϕ representing the angle 507. A carry out velocity of the treatment liquid 107 exiting the first groove 405 may be represented by the equation (U)cos ϕ. A maximum carry out flux may be represented by the equation (U)(S)cos ϕ, with S representing a cross-sectional area (e.g., depth times width) of the first groove 405. In some embodiments, as the angle 507 becomes smaller and approaches 0 degrees, the amount of the treatment liquid 107 that may accumulate in the first groove 405 is reduced. For example, as the angle 507 becomes smaller, the number of times that the first groove 405 is wound about the outer periphery 403 of the roller 401 increases. When the angle 507 is zero degrees, the first groove 405 may not extend between the first end 407 and the second end 409 of the roller 401, but, rather, may extend circumferentially about the outer periphery 403 of the roller 401. In these embodiments, with the angle 507 approaching zero degrees, the treatment liquid 107 may be less likely to accumulate and/or remain in the first groove 405, and may instead exit the first groove 405 and pass back into the reservoir 111.

In some embodiments, as the angle 507 becomes larger and approaches 90 degrees, the amount of the treatment liquid 107 that may accumulate in the first groove 405 is increased. For example, as the angle 507 becomes larger, the number of times that the first groove 405 is wound about the outer periphery 403 of the roller 401 decreases. When the angle 507 is 90 degrees, the first groove 405 may extend longitudinally between the first end 407 and the second end 409 of the roller 401 in a similar manner as illustrated in FIG. 3 (e.g., wherein the first groove 405 may extend substantially parallel to the roller axis 121, 411). In these embodiments, with the angle 507 approaching 90 degrees, the treatment liquid 107 may be more likely to accumulate and/or remain in the first groove 405. The maximum carry out flux may be influenced by the cross-sectional area of the first groove 405. For example, a larger cross-sectional area of the first groove 405 can produce a larger maximum carry out flux, which can increase the amount of the treatment liquid 107 that may be transferred from the roller 401 (e.g., within the plurality of grooves 413) to the substrate 105. In contrast, a smaller cross-sectional area of the first groove 405 can produce a smaller maximum carry out flux, which can decrease the amount of the treatment liquid 107 that may be transferred from the roller 401 (e.g., within the plurality of grooves 413) to the substrate 105.

Referring to FIG. 6, some embodiments of a cross section of the groove taken perpendicular to the groove axis of the first groove 207a, 405 are illustrated. As shown, the first groove 207a, 405 can be formed within the outer periphery 201, 403 of the roller 119, 401. In some embodiments, the first groove 207a, 405 can comprise a bottom wall 601 and a pair of sidewalls 603. The pair of sidewalls 603 may comprise a first sidewall 605 and a second sidewall 607 that may be spaced apart from one another. The bottom wall 601 can extend between the first sidewall 605 and the second sidewall 607. In some embodiments, the bottom wall 601 may be substantially planar, for example, by extending linearly between the first sidewall 605 and the second sidewall 607 in a direction orthogonal to the groove direction (e.g., with the groove direction extending along the roller axis 121, 411 between the first end 301, 407 and the second end 303, 409). In other embodiments, however, the bottom wall 601 is not limited to being planar, and may, instead, be non-planar between the first sidewall 605 and the second sidewall 607 in a direction orthogonal to the groove direction, for example, by comprising a curve, an arc, a bend, etc. In some embodiments, the bottom wall 601 can comprise an arc between the first sidewall 605 and the second sidewall 607 in a direction orthogonal to the groove direction that is substantially parallel to an arc along which an outer surface 609 of the outer periphery 201, 403 of the roller 119, 401 extends. In some embodiments, the bottom wall 601 may be substantially planar, for example, by being planar along a length of the first groove 207a, 405 between the first end 301, 407 and the second end 303, 409 of the roller 119, 401. In addition or in the alternative, in some embodiments, the bottom wall 601 can be non-planar between the first end 301, 407 and the second end 303, 409 of the roller 119, 401, such as by comprising an arc that is curved in a direction parallel to the groove direction (e.g., wherein the bottom wall 601 is non-planar along a length of the first groove 207a, 405 between the first end 301, 407 and the second end 303, 409 of the roller 119, 401). In some embodiments, the first sidewall 605 and/or the second sidewall 607 may be substantially planar, for example, by extending linearly between the outer surface 609 and the bottom wall 601. In other embodiments, however, the first sidewall 605 and/or the second sidewall 607 are not limited to being planar, and may, instead, be non-planar between the outer surface 609 and the bottom wall 601, for example, by comprising a curve, an arc, a bend, etc.

In some embodiments, the pair of sidewalls 603 can define angles relative to the bottom wall 601. For example, one or more sidewalls (e.g., the first sidewall 605 and/or the second sidewall 607) of the pair of sidewalls 603 can define an angle relative to the bottom wall 601 that may be from about 60 degrees to about 95 degrees. In some embodiments, the first sidewall 605 can define a first angle 611 relative to the bottom wall 601 that may be from about 60 degrees to about 95 degrees or from about 85 degrees to about 95 degrees. In some embodiments, the second sidewall 607 can define a second angle 613 relative to the bottom wall 601 that may be from about 60 degrees to about 95 degrees or from about 85 degrees to about 95 degrees. In some embodiments, the first angle 611 can be equal to the second angle 613 although different angles may be provided in further embodiments. In some embodiments, one or both of the first angle 611 or the second angle 613 may comprise a right angle, such that the first groove 207a may comprise a square shape or a rectangular shape profile taken along a cross section that is perpendicular to the groove axis.

In some embodiments, the first groove 207a, 405 can comprise a width 615 that may be greater than at least twice a depth 617 of the first groove 207a. The width 615 of the first groove 207a, 405 is measured between the first sidewall 605 and the second sidewall 607 (e.g., perpendicular to the first groove axis 305 along which the first groove 207a, 405 extends and parallel to the bottom wall 601) at a bottom of the first sidewall 605 and the second sidewall 607 (e.g., along the bottom wall 601). In some embodiments, the width 615 is the minimum distance between the first sidewall 605 and the second sidewall 607. In other embodiments, however, in which the first groove 207a, 405 does not comprise a bottom wall (e.g., when the first groove 207a, 405 comprises a V-shape with one or more of the first sidewall 605 or the second sidewall 607 sloping and converging towards each other and connected at bottom ends of the first sidewall 605 and the second sidewall 607), the width 615 is the maximum distance between the first sidewall 605 and the second sidewall 607. In these embodiments in which the first groove 207a, 405 comprises the V-shape without a bottom wall, the width 615 (e.g., the maximum distance between the first sidewall 605 and the second sidewall 607) is measured between top ends of the first sidewall 605 and the second sidewall 607. The depth 617 of the first groove 207a, 405 is measured between the bottom wall 601 (e.g., perpendicular to the bottom wall 601) and a plane tangent to the outer surface 609 at the location of the measurement. In some embodiments, when the bottom wall 601 is not parallel to the plane tangent to the outer surface 609 at the location of the measurement, the depth 617 may comprise the minimum distance from the plane tangent to the outer surface 609 at the location of the measurement and the bottom wall 601. In other embodiments, however, in which the first groove 207a, 405 does not comprise a bottom wall (e.g., when the first groove 207a, 405 comprises the V-shape with one or more of the first sidewall 605 or the second sidewall 607 sloping and converging towards each other and connected at bottom ends of the first sidewall 605 and the second sidewall 607), the depth 617 is the distance between the convergence of the first sidewall 605 and the second sidewall 607 (e.g., at bottom ends of the first sidewall 605 and the second sidewall 607) and the plane tangent to the outer surface 609 at the location of the measurement.

Due to the width 615 being greater than at least twice the depth 617 of the first groove 207a, the treatment liquid 107 can be received within the first groove 207a, and a continuous layer of the treatment liquid 107 about the roller 119, 401 can be maintained. While the foregoing description was made relative to the first groove 207a, 405, it will be appreciated that, in some embodiments, the other grooves (e.g., the plurality of grooves 207, 413) of the roller 119, 401 may be substantially similar in structure and function to the first groove 207a. For example, one or more of the plurality of grooves 207, 413 can comprise the pair of sidewalls 603 comprising the first sidewall 605 and the second sidewall 607, where the first sidewall 605 defines the first angle 611 relative to the bottom wall 601, and the second sidewall 607 defines the second angle 613 relative to the bottom wall 601.

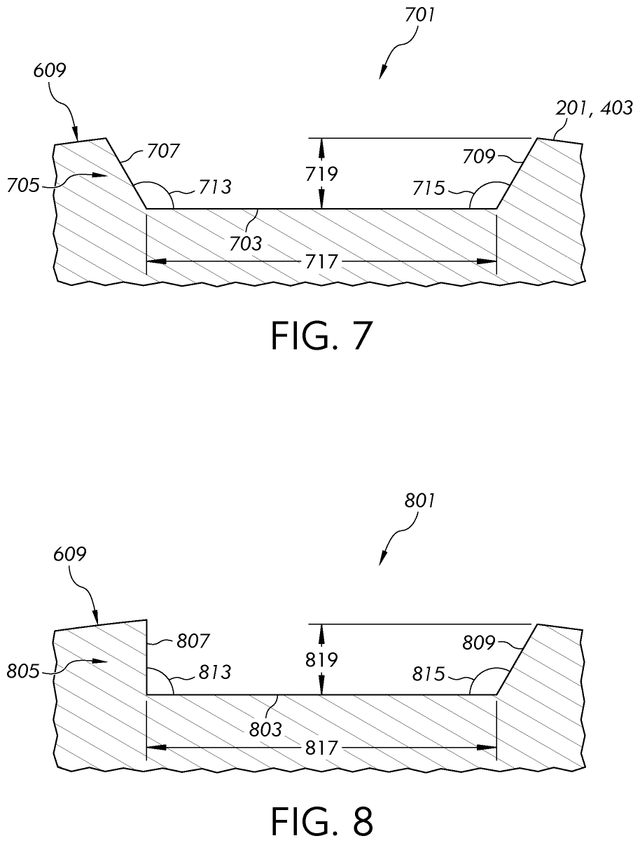

Referring to FIG. 7, further embodiments of a first groove 701 of the roller 119, 401 are illustrated as it would appear in a cross section of the first groove 701 taken perpendicular to the groove axis, in which the first groove 701 may be chamfered. In some embodiments, the first groove 701 can comprise a bottom wall 703 and a pair of sidewalls 705. The pair of sidewalls 705 may comprise a first sidewall 707 and a second sidewall 709 that may be spaced apart from one another. The bottom wall 703 can extend between the first sidewall 707 and the second sidewall 709. In some embodiments, the bottom wall 703 may be substantially planar, for example, by extending linearly between the first sidewall 707 and the second sidewall 709 in a direction orthogonal to the groove direction (e.g., with the groove direction extending along the roller axis 121, 411 between the first end 301, 407 and the second end 303, 409). In other embodiments, however, the bottom wall 703 is not limited to being planar, and may, instead, be non-planar between the first sidewall 707 and the second sidewall 709 in a direction orthogonal to the groove direction, for example, by comprising a curve, an arc, a bend, etc. In some embodiments, the bottom wall 703 can comprise an arc between the first sidewall 707 and the second sidewall 709 in a direction orthogonal to the groove direction that is substantially parallel to an arc along which the outer surface 609 of the outer periphery 201, 403 of the roller 119, 401 extends. In some embodiments, the bottom wall 703 may be substantially planar, for example, by being planar along a length of the first groove 701 between the first end 301, 407 and the second end 303, 409 of the roller 119, 401. In addition or in the alternative, in some embodiments, the bottom wall 703 can be non-planar between the first end 301, 407 and the second end 303, 409 of the roller 119, 401, such as by comprising an arc that is curved in a direction parallel to the groove direction (e.g., wherein the bottom wall 703 is non-planar along a length of the first groove 701 between the first end 301, 407 and the second end 303, 409 of the roller 119, 401). In some embodiments, the first sidewall 707 and/or the second sidewall 709 may be substantially planar, for example, by extending linearly between the outer surface 609 and the bottom wall 703. In other embodiments, however, the first sidewall 707 and/or the second sidewall 709 are not limited to being planar, and may, instead, be non-planar between the outer surface 609 and the bottom wall 703, for example, by comprising a curve, an arc, a bend, etc.

In some embodiments, the pair of sidewalls 705 can define angles relative to the bottom wall 703. For example, one or more sidewalls (e.g., the first sidewall 707 and/or the second sidewall 709) of the pair of sidewalls 705 can define an angle relative to the bottom wall 703 that may be from about 60 degrees to about 170 degrees. In some embodiments, the first sidewall 707 can define a first angle 713 relative to the bottom wall 703 that may be from about 60 degrees to about 170 degrees or from about 95 degrees to about 170 degrees. In some embodiments, the second sidewall 709 can define a second angle 715 relative to the bottom wall 703 that may be from about 60 degrees to about 170 degrees or from about 95 degrees to about 170 degrees. In some embodiments, one or more of the first angle 713 or the second angle 715 may comprise an obtuse angle, such that the first groove 701 may comprise a non-square or non-rectangular shape.

In some embodiments, the first groove 701 can comprise a width 717 that may be greater than at least twice a depth 719 of the first groove 701. The width 717 of the first groove 701 is measured between the first sidewall 707 and the second sidewall 709 (e.g., perpendicular to an axis along which the first groove 701 extends) at a bottom of the first sidewall 707 and the second sidewall 709 (e.g., along the bottom wall 703 when the bottom wall 703 is linear between the first sidewall 707 and the second sidewall 709). In some embodiments, the width 717 of the first groove 701 may be non-constant between the bottom wall 703 and a plane tangent to the outer surface 609 at the location of the measurement. For example, the width 717 of the first groove 701 can be at a minimum along the bottom wall 703 (e.g., at a bottom of the first sidewall 707 and the second sidewall 709) and at a maximum along the plane tangent to the outer surface 609 at the location of the measurement (e.g., at a top of the first sidewall 707 and the second sidewall 709). In these embodiments, the width 717 of the first groove 701 can increase from the bottom wall 703 towards the outer surface 609. The depth 719 of the first groove 701 is measured between the bottom wall 703 (e.g., perpendicular to the bottom wall 703) and a plane tangent to the outer surface 609 at the location of the measurement. Due to the width 717 being greater than at least twice the depth 719 of the first groove 701, the treatment liquid 107 can be received within the first groove 701, and a continuous layer of the treatment liquid 107 about the roller 119, 401 can be maintained. While the foregoing description was made relative to the first groove 701, it will be appreciated that one or more of the other grooves (e.g., the plurality of grooves 207, 413) of the roller 119, 401 may be substantially similar in structure and function to the first groove 701. For example, one or more of the plurality of grooves 207, 413 can comprise the pair of sidewalls 705 comprising the first sidewall 707 and the second sidewall 709, where the first sidewall 707 defines the first angle 713 relative to the bottom wall 703, and the second sidewall 709 defines the second angle 715 relative to the bottom wall 703.

Referring to FIG. 8, further embodiments of a first groove 801 of the roller 119, 401 are illustrated. In some embodiments, the first groove 801 can comprise a bottom wall 803 and a pair of sidewalls 805. The pair of sidewalls 805 may comprise a first sidewall 807 and a second sidewall 809 that may be spaced apart from one another. The bottom wall 803 can extend between the first sidewall 807 and the second sidewall 809. In some embodiments, the bottom wall 803 may be substantially planar, for example, by extending linearly between the first sidewall 807 and the second sidewall 809 in a direction orthogonal to the groove direction (e.g., with the groove direction extending along the roller axis 121, 411 between the first end 301, 407 and the second end 303, 409). In other embodiments, however, the bottom wall 803 is not limited to being planar, and may, instead, be non-planar between the first sidewall 807 and the second sidewall 809 in a direction orthogonal to the groove direction, for example, by comprising a curve, an arc, a bend, etc. In some embodiments, the bottom wall 803 can comprise an arc between the first sidewall 807 and the second sidewall 809 in a direction orthogonal to the groove direction that is substantially parallel to an arc along which the outer surface 609 of the outer periphery 201, 403 of the roller 119, 401 extends. In some embodiments, the bottom wall 803 may be substantially planar, for example, by being planar along a length of the first groove 801 between the first end 301, 407 and the second end 303, 409 of the roller 119, 401. In addition or in the alternative, in some embodiments, the bottom wall 803 can be non-planar between the first end 301, 407 and the second end 303, 409 of the roller 119, 401, such as by comprising an arc that is curved in a direction parallel to the groove direction (e.g., wherein the bottom wall 803 is non-planar along a length of the first groove 801 between the first end 301, 407 and the second end 303, 409 of the roller 119, 401). In some embodiments, the first sidewall 807 and/or the second sidewall 809 may be substantially planar, for example, by extending linearly between the outer surface 609 and the bottom wall 803. In other embodiments, however, the first sidewall 807 and/or the second sidewall 809 are not limited to being planar, and may, instead, be non-planar between the outer surface 609 and the bottom wall 803, for example, by comprising a curve, an arc, a bend, etc.

In some embodiments, the pair of sidewalls 805 can define angles relative to the bottom wall 803. For example, one or more sidewalls (e.g., the first sidewall 807 and/or the second sidewall 809) of the pair of sidewalls 805 can define an angle relative to the bottom wall 803 that may be from about 60 degrees to about 170 degrees. In some embodiments, the first sidewall 807 can define a first angle 813 relative to the bottom wall 803 that may be from about 60 degrees to about 170 degrees. For example, the first angle 813 may be from about 60 degrees to about 95 degrees or from about 85 degrees to about 95 degrees. In some embodiments, the first sidewall 807 can comprise a right angle. In some embodiments, the second sidewall 809 can define a second angle 815 relative to the bottom wall 803 that may be from about 60 degrees to about 170 degrees, or from about 95 degrees to about 170 degrees. In some embodiments, the second angle 815 may comprise an obtuse angle. In this way, in some embodiments, the first angle 813 and the second angle 815 may be different.

In some embodiments, the first groove 801 comprises a width 817 that may be greater than at least twice a depth 819 of the first groove 801. The width 817 of the first groove 801 is measured between the first sidewall 807 and the second sidewall 809 (e.g., perpendicular to an axis along which the first groove 801 extends and parallel to the bottom wall 803) at a bottom of the first sidewall 807 and the second sidewall 809 (e.g., along the bottom wall 803). In some embodiments, the width 817 of the first groove 801 may be non-constant between the bottom wall 803 and a plane tangent to the outer surface 609 at the location of the measurement. For example, the width 817 of the first groove 801 can be at a minimum along the bottom wall 803 (e.g., at a bottom of the first sidewall 807 and the second sidewall 809) and at a maximum along the plane tangent to the outer surface 609 at the location of the measurement (e.g., at a top of the first sidewall 807 and the second sidewall 809). In these embodiments, the width 817 of the first groove 801 can increase from the bottom wall 803 towards the outer surface 609. The depth 819 of the first groove 801 is measured between the bottom wall 803 (e.g., perpendicular to the bottom wall 803) and a plane tangent to the outer surface 609 at the location of the measurement. Due to the width 817 being greater than at least twice the depth 819 of the first groove 801, the treatment liquid 107 can be received within the first groove 801, and a continuous layer of the treatment liquid 107 about the roller 119, 401 can be maintained. While the foregoing description was made relative to the first groove 801, it will be appreciated that one or more of the other grooves (e.g., the plurality of grooves 207, 413) of the roller 119, 401 may be substantially similar in structure and function to the first groove 801. For example, one or more of the plurality of grooves 207, 413 can comprise the pair of sidewalls 805 comprising the first sidewall 807 and the second sidewall 809, where the first sidewall 807 defines the first angle 813 relative to the bottom wall 803, and the second sidewall 809 defines the second angle 815 relative to the bottom wall 803.

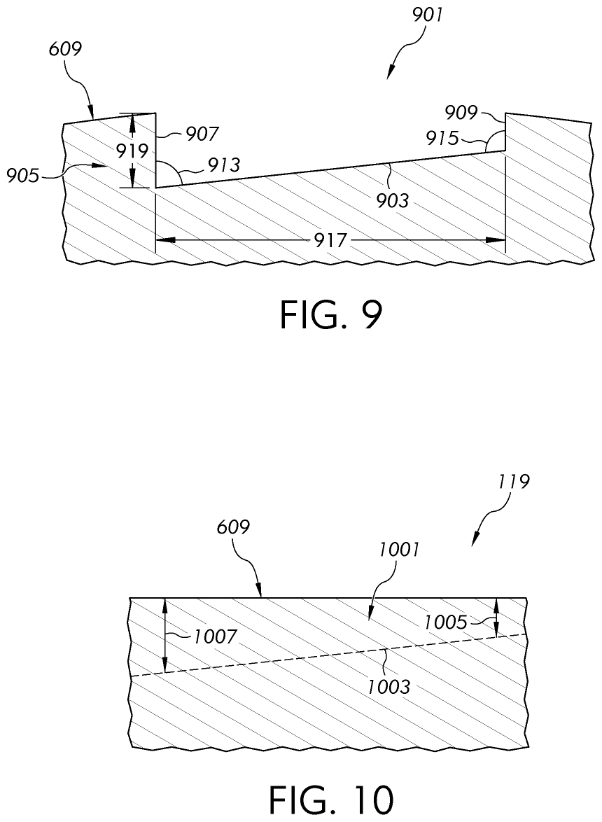

Referring to FIG. 9, further embodiments of a first groove 901 of the roller 119, 401 are illustrated. In some embodiments, the first groove 901 can comprise a bottom wall 903 and a pair of sidewalls 905. The pair of sidewalls 905 may comprise a first sidewall 907 and a second sidewall 909 that may be spaced apart from one another. The bottom wall 903 can extend between the first sidewall 907 and the second sidewall 909. In some embodiments, the bottom wall 903 may be substantially planar, for example, by extending linearly between the first sidewall 907 and the second sidewall 909 in a direction orthogonal to the groove direction (e.g., with the groove direction extending along the roller axis 121, 411 between the first end 301, 407 and the second end 303, 409). In other embodiments, however, the bottom wall 903 is not limited to being planar, and may, instead, be non-planar between the first sidewall 907 and the second sidewall 909 in a direction orthogonal to the groove direction, for example, by comprising a curve, an arc, a bend, etc. In some embodiments, the bottom wall 903 can comprise an arc between the first sidewall 907 and the second sidewall 909 in a direction orthogonal to the groove direction that is substantially parallel to an arc along which the outer surface 609 of the outer periphery 201, 403 of the roller 119, 401 extends. In some embodiments, the bottom wall 903 may be substantially planar, for example, by being planar along a length of the first groove 901 between the first end 301, 407 and the second end 303, 409 of the roller 119, 401. In addition or in the alternative, in some embodiments, the bottom wall 903 can be non-planar between the first end 301, 407 and the second end 303, 409 of the roller 119, 401, such as by comprising an arc that is curved in a direction parallel to the groove direction (e.g., wherein the bottom wall 903 is non-planar along a length of the first groove 901 between the first end 301, 407 and the second end 303, 409 of the roller 119, 401). In some embodiments, the first sidewall 907 and/or the second sidewall 909 may be substantially planar, for example, by extending linearly between the outer surface 609 and the bottom wall 903. In other embodiments, however, the first sidewall 907 and/or the second sidewall 909 are not limited to being planar, and may, instead, be non-planar between the outer surface 609 and the bottom wall 903, for example, by comprising a curve, an arc, a bend, etc.

In some embodiments, the pair of sidewalls 905 can define angles relative to the bottom wall 903. For example, one or more sidewalls (e.g., the first sidewall 907 and/or the second sidewall 909) of the pair of sidewalls 905 can define an angle relative to the bottom wall 903 that may be from about 60 degrees to about 170 degrees. In some embodiments, the first sidewall 907 can define a first angle 913 relative to the bottom wall 903 that may be from about 60 degrees to about 85 degrees, such that the first sidewall 807 can comprise an acute angle. In some embodiments, the second sidewall 909 can define a second angle 915 relative to the bottom wall 903 that may be from about 95 degrees to about 170 degrees. In some embodiments, the second angle 915 may comprise an obtuse angle, such that the first angle 913 and the second angle 915 may be different.

In some embodiments, the first groove 901 can comprise a width 917 that may be greater than at least twice a depth 919 of the first groove 901. The width 917 of the first groove 901 is measured between the first sidewall 907 and the second sidewall 909 (e.g., perpendicular to an axis along which the first groove 901 extends and perpendicular to the first sidewall 907 and the second sidewall 909) at a bottom of the shorter sidewall (e.g., the second sidewall 909). The depth 919 of the first groove 901 is measured between the bottom wall 903 and a plane tangent to the outer surface 609 at the location of the measurement. For example, the depth 919 is measured at a maximum depth of the first groove 901, for example, along the first sidewall 907 between the bottom wall 903 and a plane tangent to the outer surface 609 at the location of the measurement (e.g., at the first sidewall 907). In some embodiments, the depth 919 of a groove (e.g., the first groove 901) may be non-constant along the width 917 of the groove (e.g., the first groove 901), such that the depth 919 of the first groove 901 may be non-constant between the first sidewall 907 and the second sidewall 909. For example, the depth 919 may be at a minimum along the second sidewall 909 (e.g., at the right-hand side of the bottom wall 903) and at a maximum along the first sidewall 907 (e.g., at the left-hand size of the bottom wall 903). In these embodiments, the depth 919 of the first groove 901 can increase from the first sidewall 807 towards the second sidewall 809 along the bottom wall 803. Due to the width 917 being greater than at least twice the depth 919 of the first groove 901, the treatment liquid 107 can be received within the first groove 901, and a continuous layer of the treatment liquid 107 about the roller 119, 401 can be maintained. While the foregoing description was made relative to the first groove 901, it will be appreciated that one or more of the other grooves (e.g., the plurality of grooves 207, 413) of the roller 119, 401 may be substantially similar in structure and function to the first groove 901. For example, one or more of the plurality of grooves 207, 413 can comprise the pair of sidewalls 905 comprising the first sidewall 907 and the second sidewall 909, where the first sidewall 907 defines the first angle 913 relative to the bottom wall 903, and the second sidewall 909 defines the second angle 915 relative to the bottom wall 903.

Referring to FIG. 10, a sectional view of a portion of the roller 119 along line 10-10 of FIG. 3 is illustrated. In some embodiments, a depth of a groove 1001 may be non-constant along a length of the groove 1001. For example, the groove 1001 may comprise a bottom wall 1003 extending between the first end 301 and the second end 303 of the roller 119. The bottom wall 1003 can be angled along the length of the roller 119, such that the depth of the groove 1001 may be non-constant between the first end 301 and the second end 303 of the roller 119. In some embodiments, the groove 1001 can comprise a first depth 1005 at a first location and a second depth 1007 at a second location. The first depth 1005 is measured between the bottom wall 1003 and the outer surface 609 at the first location. The second depth 1007 is measured between the bottom wall 1003 and the outer surface 609 at the second location. In some embodiments, the first depth 1005 may be larger than the second depth 1007 due to the bottom wall 1003 being angled. In this way, the depth of the groove 1001 may be non-constant along one or more of the width of the groove (e.g., as illustrated in FIG. 9) or a length of the groove (e.g., as illustrated in FIG. 10).

While the foregoing description was made relative to the first groove 1001, it will be appreciated that one or more of the other grooves (e.g., the plurality of grooves 207, 413, the first grooves 207a, 405, 701, 801, 901, etc.) of the roller 119, 401 may be substantially similar in structure and function to the first groove 1001. For example, one or more of the grooves 207, 207a, 405, 413, 701, 801, 901 can comprise the angled bottom wall 1003 that may comprise a non-constant depth (e.g., the first depth 1005 at the first location and the second depth 1007 at the second location). In this way, one or more of the grooves 207, 207a, 405, 413, 701, 801, 901 of the roller 119, 401 can comprise one or more of non-chamfered sidewalls (e.g., illustrated in FIG. 6), chamfered sidewalls (e.g., illustrated in FIG. 7), partially chamfered sidewalls (e.g., illustrated in FIG. 8), a non-constant depth along the width of the groove (e.g., illustrated in FIG. 9), or a non-constant depth along the length of the groove (e.g., illustrated in FIG. 10).

Referring to FIG. 2, some embodiments of methods of treating the substrate 105 are illustrated. In some embodiments, methods of treating the substrate 105 can comprise adding the treatment liquid 107 to the reservoir 111 of the container 109. By adding the treatment liquid 107 to the reservoir 111, the reservoir 111 may be partially filled (e.g., as illustrated) or completely filled. In some embodiments, when partially filled, the free surface 205 of the treatment liquid 107 is below the plane defined by the top surface of the container 109. In some embodiments, when completely filled, the free surface 205 of the treatment liquid 107 may be co-planar with the plane defined by the top surface of the container 109. The treatment liquid 107 can be added to the reservoir 111 of the container 109 in several ways, for example, via the inlet conduit 115, for example. In some embodiments, the treatment liquid 107 can be removed from the reservoir 111 via the outlet conduit 117 so as to lower a level of the free surface 205 of the treatment liquid 107.

In some embodiments, methods of treating the substrate 105 can comprise moving the substrate 105 along the travel direction 113 of a travel path 213 as the roller 119 rotates (e.g., along the rotational direction 125) about the roller axis 121. The substrate 105 can be moved (e.g., left to right in FIG. 2) along the travel direction 113, with the leading end 108 illustrated with a solid line in a first position, and with dashed lines in a second position. In some embodiments, a velocity of the substrate 105 along the travel direction 113 can be greater than, equal to, or less than the rotational velocity of the roller 119 along the rotational direction 125. For example, as the substrate 105 moves along the travel direction 113, the roller 119 can simultaneously rotate such that the rotational direction 125 of the roller 119 (e.g., clockwise in FIG. 2) can match the travel direction 113 of the substrate 105 (e.g., left to right in FIG. 2).

In some embodiments, methods of treating the substrate 105 can comprise contacting the treatment liquid 107 contained in the reservoir 111 of the container 109 with the portion 203 of the outer periphery 201 of the roller 119, with the outer periphery 201 comprising the first groove 207a. In some embodiments, the contacting the treatment liquid 107 contained in the reservoir 111 of the container 109 with the portion 203 of the outer periphery 201 of the roller 119 may comprise immersing the portion 203 of the outer periphery 201 of the roller 119 in the treatment liquid 107 contained in the reservoir 111. By immersing the portion 203 of the outer periphery 201 in the treatment liquid 107, some or all of the outer periphery 201 of the roller 119 may be immersed in the treatment liquid 107 beneath the free surface 205. For example, in the embodiments of FIGS. 1-2, the portion 203 of the outer periphery 201 that is immersed in the treatment liquid 107 may comprise less than half of a diameter of the roller 119. In other embodiments, however, greater than half of the diameter of the roller 119 may be immersed in the treatment liquid 107 and positioned below the free surface 205. In some embodiments, the contacting the treatment liquid 107 contained in the reservoir 111 of the container 109 with the portion 203 of the outer periphery 201 of the roller 119 can cause the treatment liquid 107 to enter the first groove 207a. For example, by entering the first groove 207a, the treatment liquid 107 is not limited to filling the first groove 207a. Rather, in some embodiments, the treatment liquid 107 can enter the first groove 207a and partially fill the first groove 207a, such that less than all of the first groove 207a is filled with the treatment liquid 107.

In some embodiments, methods of treating the substrate 105 can comprise rotating the roller 119 about the roller axis 121 to continuously distribute the treatment liquid 107 around the outer periphery 201 and within the first groove 207a. By being continuously distributed around the outer periphery 201 and within the first groove 207a, the treatment liquid 107 may form an uninterrupted layer 206 around the roller 119, with the layer 206 free of gaps, voids, spaces, or other discontinuities in the treatment liquid 107. In some embodiments, the continuously distributed layer 206 of the treatment liquid 107 may comprise a minimum thickness “T2” that is greater than zero. For example, the continuously distributed layer 206 of the treatment liquid 107 may comprise a thickness T2 of from about 22 μm to about 24 μm. In other embodiments, the continuously distributed layer 206 of the treatment liquid 107 may comprise a thickness T2 of from about 30 μm to about 34 μm. In some embodiments, the roller 119 can be rotated about the roller axis 121 with a drive mechanism that may be connected to the roller 119 via the roller shaft 123. The drive mechanism may apply a torque to the roller shaft 123, which can cause the roller 119 to rotate about the roller axis 121 in the rotational direction 125.

In some embodiments, methods of treating the substrate 105 can comprise transferring the treatment liquid 107 from the outer periphery 201 to the first major surface 103a of the substrate 105 as the roller 119 rotates. For example, as the roller 119 rotates, the treatment liquid 107 may be continuously distributed as a layer 206 about the outer periphery 201 of the roller 119. The first major surface 103a of the substrate 105 may be in close proximity to the outer periphery 201 of the roller 119, such that a distance separating the outer periphery 201 of the roller 119 and the first major surface 103a may be less than the thickness T2 of the layer 206 of the treatment liquid 107. While the first major surface 103a of the substrate 105 is in close proximity to the outer periphery 201 of the roller 119, in some embodiments, the first major surface 103a may not contact the outer periphery 201. Rather, the first major surface 103a of the substrate 105 can contact and pass through the layer 206 of the treatment liquid 107 that is continuously distributed around the outer periphery 201. In this way, the treatment liquid 107 can be transferred to the from the outer periphery 201 of the roller 119 to the first major surface 103a of the substrate 105.

FIG. 11 illustrates a relationship between a width of the first groove 207a and a depth of the first groove 207a while maintaining the continuous distribution of the treatment liquid 107 around the outer periphery 201 and within the first groove 207a. The x-axis (e.g., horizontal axis) represents the groove width (e.g., μm) while the y-axis (e.g., vertical axis) represents the groove depth (e.g., μm). A line 1100 represents a boundary between the treatment liquid 107 being continuously distributed versus non-continuously distributed (e.g., discontinuous) about the outer periphery 201 of the roller 119. In these embodiments, the line 1100 is representative of the first groove 207a comprising the non-chamfered shape (e.g., illustrated in FIG. 6). In some embodiments, when the groove depth exceeds a critical groove depth (e.g., a point on the line 1100) at a given groove width, the treatment liquid 107 becomes discontinuous and may comprise gaps, voids, spaces, or other discontinuities. This discontinuity may therefore be represented by groove depths above the line 1100. For example, when the groove width is about 650 μm, the treatment liquid 107 may be discontinuous if the groove depth is greater than about 38 μm. When the groove depth is equal to or less than a critical groove depth (e.g., a point on the line 1100) at a given groove width, the treatment liquid 107 may be continuously distributed. This discontinuity may therefore be represented by groove depths below the line 1100. For example, when the groove width is about 650 μm, the treatment liquid 107 may be continuous if the groove depth is less than or equal to about 38 μm.

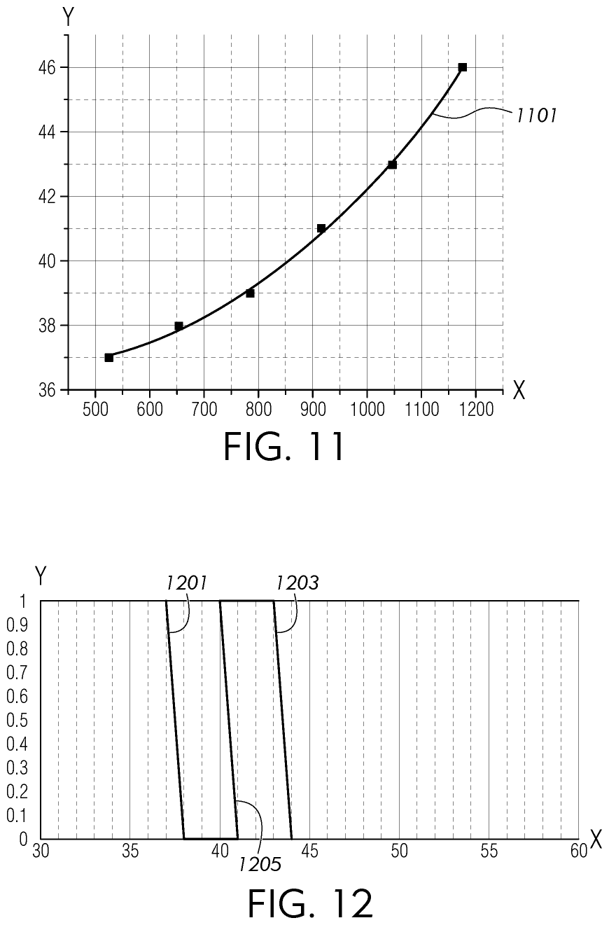

FIG. 12 illustrates a relationship between a depth of the first groove 207a and a state of the treatment liquid 107 for given widths of the first groove 207a. The x-axis (e.g., horizontal axis) represents the groove depth (e.g., μm) while the y-axis (e.g., vertical axis) represents the state of the treatment liquid 107. When the layer 206 of the treatment liquid 107 is continuously distributed around the outer periphery 201 and within the first groove 207a, the state is 1. When the layer 206 of the treatment liquid 107 is discontinuously distributed around the outer periphery 201 and within the first groove 207a, the state is 0. In these embodiments, the continuously distributed layer 206 of the treatment liquid 107 comprises a thickness that is about 24 μm. A first line 1201 represents the first groove 207a comprising a width that is about 520 μm. A second line 1203 represents the first groove 207a comprising a width that is about 1040 μm. A third line 1205 represents the first groove 207a comprising a width that is about 1570 μm. In these embodiments, the lines 1201, 1203, 1205 is representative of the first groove 207a comprising the non-chamfered shape (e.g., illustrated in FIG. 6).

In some embodiments, for the first groove 207a comprising a width that is about 520 μm (e.g., first line 1201), the treatment liquid 107 may be continuous for groove depths that are less than or equal to about 37 μm. The treatment liquid 107 may transition from being continuously distributed to being discontinuously distributed for groove depths that are from about 37 μm to about 38 μm. The treatment liquid 107 may be discontinuous for groove depths that are greater than or equal to about 38 μm. In some embodiments, for the first groove 207a comprising a width that is about 1040 μm (e.g., second line 1203), the treatment liquid 107 may be continuous for groove depths that are less than or equal to about 43 μm. The treatment liquid 107 may transition from being continuously distributed to being discontinuously distributed for groove depths that are from about 43 μm to about 44 μm. The treatment liquid 107 may be discontinuous for groove depths that are greater than or equal to about 44 μm. In some embodiments, for the first groove 207a comprising a width that is about 1570 μm (e.g., third line 1205), the treatment liquid 107 may be continuous for groove depths that are less than or equal to about 40 μm. The treatment liquid 107 may transition from being continuously distributed to being discontinuously distributed for groove depths that are from about 40 μm to about 41 μm. The treatment liquid 107 may be discontinuous for groove depths that are greater than or equal to about 41 μm. Therefore, as illustrated in FIG. 12, a greater width of the first groove 207a, such as the 1040 μm width as compared to the 520 μm width, can allow for a greater depth, such as a depth of about 42 μm-43 μm as compared to a depth of about 37 μm-38 μm, while maintaining the continuous distribution of the treatment liquid 107. However, beyond a certain width, such as the 1040 μm width as compared to the 1570 μm width, the depth of the first groove 207a may decrease when transitioning from the continuous distribution to the discontinuous distribution. This decrease may be due, in part, to the increased surface area of the roller 119 from the increased width of the grooves.

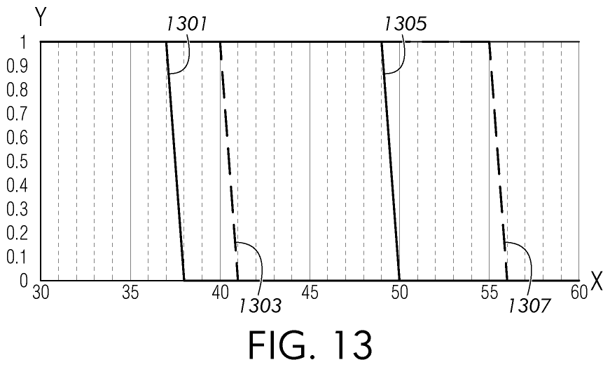

FIG. 13 illustrates a relationship between a depth of the first groove 207a and a state of the treatment liquid 107 for given shapes of the first groove 207a and thicknesses of the layer 206 of the treatment liquid 107. The x-axis (e.g., horizontal axis) represents the groove depth (e.g., μm) while the y-axis (e.g., vertical axis) represents the state of the treatment liquid 107. When the layer 206 of the treatment liquid 107 is continuously distributed around the outer periphery 201 and within the first groove 207a, the state is 1. When the layer 206 of the treatment liquid 107 is discontinuously distributed around the outer periphery 201 and within the first groove 207a, the state is 0. In these embodiments, the first groove 207a comprises a width that is about 520 μm. A first line 1301 represents the first groove 207a comprising a non-chamfered shape (e.g., illustrated in FIG. 6) and the continuously distributed layer 206 of the treatment liquid 107 comprising a thickness that is about 24 μm. A second line 1303 represents the first groove 701 comprising a chamfered shape (e.g., illustrated in FIG. 7) and the continuously distributed layer 206 of the treatment liquid 107 comprising a thickness that is about 24 μm. A third line 1305 represents the first groove 207a comprising a non-chamfered shape (e.g., illustrated in FIG. 6) and the continuously distributed layer 206 of the treatment liquid 107 comprising a thickness that is about 32 μm. A fourth line 1307 represents the first groove 701 comprising a chamfered shape (e.g., illustrated in FIG. 7) and the continuously distributed layer 206 of the treatment liquid 107 comprising a thickness that is about 32 μm.

In some embodiments, the first line 1301 transitions from the continuous state to the discontinuous state for groove depths that are from about 37 μm to about 38 μm. The second line 1303 can transition from the continuous state to the discontinuous state for groove depths that are from about 40 μm to about 41 μm. In this way, when the first groove 701 is chamfered, the groove depth can be about 3 μm greater as compared to the non-chamfered shape of the first groove 207a. In some embodiments, the third line 1305 transitions from the continuous state to the discontinuous state for groove depths that are from about 49 μm to about 50 μm. The fourth line 1307 can transition from the continuous state to the discontinuous state for groove depths that are from about 55 μm to about 56 μm. In this way, when the first groove 701 is chamfered, the groove depth can be about 6 μm greater. Therefore, as illustrated in FIG. 13, when the thickness of the treatment liquid 107 and the width of the first groove 207a are held constant, the depth of the first groove 207a can increase for a chamfered first groove 701 (e.g., illustrated in FIG. 7) as compared to a non-chamfered first groove 207a (e.g., illustrated in FIG. 6) when transitioning from the continuous distribution to the discontinuous distribution.

In some embodiments, the substrate treating apparatus 101 can provide for improved control when applying the treatment liquid 107 to the substrate 105. For example, by providing the roller 119, 401 with the plurality of grooves 207, 207a, 405, 413, 701, 801, 901, a layer 206 of the treatment liquid 107 can be continuously distributed about the outer periphery 201 of the roller 119, 401. When there are areas of the outer periphery 201 of the roller 119, 401 that are not covered with the treatment liquid 107, then the treatment liquid 107 is not continuously distributed. With the treatment liquid 107 continuously distributed, a more consistent application of the treatment liquid to the first major surface 103a of the substrate 105 can be achieved. In addition, the roller 119, 401 with the plurality of grooves 207, 207a, 405, 413, 701, 801, 901 can reduce the likelihood of splashing the treatment liquid 107 onto the second major surface 103b at the trailing end of the substrate 105. For example, due to the treatment liquid 107 being continuously distributed about the outer periphery 201 of the roller 119, 401, a reduced amount of treatment liquid 107 may be used to treat the first major surface 103a of the substrate 105. As a result, splashing of excess treatment liquid 107 (e.g., onto the second major surface 103b) may likewise be reduced. In addition or in the alternative, due to the reduced splashing of excess treatment liquid 107, costly maintenance and/or upgrades to equipment may be reduced, thus prolonging the lifespan of existing equipment. Likewise, by decreasing or redistributing the amount of treatment liquid 107 that is transferred to the first major surface 103a of the substrate, the substrate treating apparatus 101 can generate savings in costs due to an extended live of the treatment liquid 107. In addition, the roller 119, 401 can be readily replaced with a new roller when an existing roller 119, 401 is due for replacement. In addition or in the alternative, it may be desirable to replace an existing roller 119, 401 with a different roller comprising different groove properties (e.g., chamfered vs. non-chamfered, extending longitudinally vs. helically wound, constant groove depth or non-constant groove depth, etc.).

Accordingly, the following nonlimiting embodiments are exemplary of the present disclosure.

Embodiment 1. A substrate treating apparatus can comprise a container comprising a reservoir and a roller rotatably mounted relative to the container, where a portion of an outer periphery of the roller may be positioned in the reservoir, and where the outer periphery can comprise a first groove comprising a width greater than at least twice a depth of the first groove.

Embodiment 2. The substrate treating apparatus of embodiment 1, wherein the first groove can comprise a bottom wall and a pair of sidewalls.

Embodiment 3. The substrate treating apparatus of embodiment 2, wherein one or more sidewalls of the pair of sidewalls can define an angle relative to the bottom wall that may be from about 60 degrees to about 170 degrees.

Embodiment 4. The substrate treating apparatus of embodiment 3, wherein the angle may be from about 60 degrees to about 95 degrees.

Embodiment 5. The substrate treating apparatus of any one of embodiments 1-4, wherein the first groove can extend along a first groove axis that may be substantially parallel to a roller axis along which the roller extends and about which the roller rotates.

Embodiment 6. The substrate treating apparatus of any one of embodiments 1-4, wherein the first groove may be helically wound about the roller.

Embodiment 7. The substrate treating apparatus of any one of embodiments 1-6, wherein the depth of the groove may be non-constant along one or more of the width of the groove or a length of the groove.

Embodiment 8. A substrate treating apparatus comprising a container comprising a reservoir, and a roller rotatably mounted relative to the container about a roller axis along which the roller extends, where a portion of an outer periphery of the roller is positioned in the reservoir, and the outer periphery can comprise a first groove extending between a first end and a second end of the roller.

Embodiment 9. The substrate treating apparatus of embodiment 8, wherein the roller comprises a porous material.

Embodiment 10. The substrate treating apparatus of any one of embodiments 8-9, wherein the reservoir contains a treatment liquid.

Embodiment 11. The substrate treating apparatus of embodiment 10, wherein the portion of the outer periphery of the roller positioned in the reservoir may be in contact with the treatment liquid.

Embodiment 12. The substrate treating apparatus of any one of embodiments 8-11, wherein the first groove can comprise a bottom wall and a pair of sidewalls.

Embodiment 13. The substrate treating apparatus of embodiment 12, wherein one or more sidewalls of the pair of sidewalls can define an angle relative to the bottom wall that may be from about 60 degrees to about 170 degrees.

Embodiment 14. The substrate treating apparatus of embodiment 13, the angle may be from about 60 degrees to about 95 degrees.

Embodiment 15. The substrate treating apparatus of any one of embodiments 8-14, wherein the first groove can extend along a first groove axis that may be substantially parallel to the roller axis.

Embodiment 16. The substrate treating apparatus of any one of embodiments 8-14, wherein the first groove can be helically wound about the roller.

Embodiment 17. A method of treating a substrate, comprising contacting a treatment liquid contained in a reservoir of a container with a portion of an outer periphery of a roller, the outer periphery comprising a first groove. The method can further comprise rotating the roller about a roller axis to continuously distribute the treatment liquid around the outer periphery and within the first groove. The method can further comprise transferring the treatment liquid from the outer periphery to a first major surface of the substrate as the roller rotates.

Embodiment 18. The method of embodiment 17, wherein the contacting the treatment liquid contained in the reservoir of the container with the portion of the outer periphery of the roller causes the treatment liquid to enter the first groove.

Embodiment 19. The method of any one of embodiments 17-18, wherein the contacting the treatment liquid contained in the reservoir of the container with the portion of the outer periphery of the roller comprises immersing the portion of the outer periphery of the roller in the treatment liquid contained in the reservoir.

Embodiment 20. The method of any one of embodiments 17-19, further comprising moving the substrate along a travel direction of a travel path as the roller rotates about the roller axis.

Embodiment 21. The method of any one of claims 17-20, wherein the treatment liquid comprises one or more of an etchant, an ink, a liquid polymer, or water.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In some embodiments, “substantially similar” may denote values within about 10% of each other, for example within about 5% of each other, or within about 2% of each other.

As used herein, the terms “comprising” and “including,” and variations thereof shall be construed as synonymous and open-ended, unless otherwise indicated.

It should be understood that while various embodiments have been described in detail with respect to certain illustrative and specific embodiments thereof, the present disclosure should not be considered limited to such, as numerous modifications and combinations of the disclosed features are possible without departing from the scope of the following claims.

What is claimed is:

1. A substrate treating apparatus, comprising:
a container comprising a reservoir; and
a roller rotatably mounted relative to the container, a portion of an outer periphery of the roller positioned in the reservoir, the outer periphery comprising a first groove comprising a width greater than at least twice a depth of the first groove.

2. The substrate treating apparatus of claim 1, wherein the first groove comprises a bottom wall and a pair of sidewalls.

3. The substrate treating apparatus of claim 2, wherein one or more sidewalls of the pair of sidewalls define an angle relative to the bottom wall that is from about 60 degrees to about 170 degrees.

4. The substrate treating apparatus of claim 3, wherein the angle is from about 60 degrees to about 95 degrees.

5. The substrate treating apparatus of claim 1, wherein the first groove extends along a first groove axis substantially parallel to a roller axis along which the roller extends and about which the roller rotates.

6. The substrate treating apparatus of claim 1, wherein the first groove is helically wound about the roller.

7. The substrate treating apparatus of claim 1, wherein the depth of the groove is non-constant along one or more of the width of the groove or a length of the groove.

8. A substrate treating apparatus, comprising:
a container comprising a reservoir; and
a roller rotatably mounted relative to the container about a roller axis along which the roller extends, a portion of an outer periphery of the roller positioned in the reservoir, the outer periphery comprising a first groove extending between a first end and a second end of the roller.

9. The substrate treating apparatus of claim 8, wherein the roller comprises a porous material.

10. The substrate treating apparatus of claim 8, wherein the reservoir contains a treatment liquid.

11. The substrate treating apparatus of claim 10, wherein the portion of the outer periphery of the roller positioned in the reservoir is in contact with the treatment liquid.

12. The substrate treating apparatus of claim 8, wherein the first groove comprises a bottom wall and a pair of sidewalls.

13. The substrate treating apparatus of claim 12, wherein one or more sidewalls of the pair of sidewalls define an angle in a range from about 60 degrees to about 170 degrees relative to the bottom wall.

14. The substrate treating apparatus of claim 13, wherein the angle is in a range from about 60 degrees to about 95 degrees.

15. The substrate treating apparatus of claim 8, wherein the first groove extends along a first groove axis substantially parallel to the roller axis.

16. The substrate treating apparatus of claim 8, wherein the first groove is helically wound about the roller.

17. A method of treating a substrate, comprising:
contacting a treatment liquid contained in a reservoir of a container with a portion of an outer periphery of a roller, the outer periphery comprising a first groove;
rotating the roller about a roller axis to distribute the treatment liquid around the outer periphery and within the first groove; and
transferring the treatment liquid from the outer periphery to a first major surface of the substrate as the roller rotates.

18. The method of claim 17, wherein the contacting the treatment liquid contained in the reservoir of the container with the portion of the outer periphery of the roller causes the treatment liquid to enter the first groove.

19. The method of claim 17, wherein the contacting the treatment liquid contained in the reservoir of the container with the portion of the outer periphery of the roller comprises immersing the portion of the outer periphery of the roller in the treatment liquid contained in the reservoir.

20. The method of claim 17, further comprising moving the substrate along a travel direction of a travel path as the roller rotates about the roller axis.

21. (canceled)
